(19) United States
(12) Patent Application Publication
(10) Pub. No.: US 2021/0048856 A1
(43) Pub. Date: Feb. 18, 2021

(54) DISPLAY DEVICE

(71) Applicant: AU Optronics Corporation, HSIN-CHU (TW)

(72) Inventors: TIEN-LU HO, HSIN-CHU (TW); KENG-JU LIU, Hsinchu County (TW)

(21) Appl. No.: 16/922,320

(22) Filed: Jul. 7, 2020

(30) Foreign Application Priority Data
Aug. 14, 2019 (TW) 108128839

(51) Int. Cl. G06F 1/18; G09F 9/30

(52) U.S. Cl. CPC G06F 1/181; G09F 9/30

(57) ABSTRACT

A display device includes a display panel having a bottom surface, a frame disposed along a periphery of the display panel, a first convex structure, and a block. The frame has a support surface configured to support the bottom surface. The first convex structure protrudes from the support surface, and is located between the support surface and the bottom surface and distributed along at least a portion of the periphery of the display panel. The block has a first surface and a second surface. The first surface is connected to the bottom surface; the second surface at least partially abuts against a top portion of the first convex structure to cause a local deformation of the block. The block has a flexibility larger than that of the first convex structure.

### BACKGROUND OF THE INVENTION

### 1. Field of the Invention

The invention generally relates to a display device. Particularly, the invention relates to a display device having a block abutting against a convex structure.

### 2. Description of the Prior Art

In order to position the display panel in the display device and prevent dusts from entering the display panel, the display panel is generally fixed on the frame by a component with adhesives on two sides, such as double-sided tape. In the case that the display panel is attached to the frame by adhesives on two sides of the component, when the display panel undergoes expansion, contraction, warpage, or deformation of other forms or causes, the firm connection between the display panel and the frame will further amplify the deformation of the display panel or cause uneven force to damage the optical configuration of the display panel. Consequently, the appearance of the display panel may be deteriorated, and unexpected defects such as light leakage in the dark state may be further generated, affecting the display quality or display functionability.

In the case that the display panel is not firmly adhered to the frame, but merely laid on the frame directly or indirectly through intervening materials, the display panel can move easily and is difficult to be accurately positioned in the display device. Moreover, when the display panel undergoes expansion, contraction, warpage, or deformation of other forms or causes, the loose connection between the display panel and the frame may increase the gap between the boundary of the display panel and the frame due to deformation, increasing the chance of dusts or impurities entering the display panel.

### SUMMARY OF THE INVENTION

It is an aspect of the invention to provide a display device, which includes a display panel having a bottom surface, a frame disposed along a periphery of the display panel, a first convex structure, and a block. The frame has a support surface configured to support the bottom surface. The first convex structure protrudes from the support surface and is located between the support surface and the bottom surface and distributed along at least a portion of the periphery of the display panel. The block has a first surface and a second surface. The first surface is connected to the bottom surface; the second surface at least partially abuts against a top portion of the first convex structure to cause a local deformation of the block. The block has a flexibility larger than that of the first convex structure.

According to various embodiments, the display device of the invention can stably position the display panel on the frame by pressing the first convex structure into the deformable block. When the display panel undergoes expansion, contraction, warpage, or deformation of other forms or causes, due to the conformal deformation of the block, the display panel can maintain a stable connection with the frame without being pulled or restrained by the frame, thereby reducing the possibility of degrading or damaging the configuration or appearance of the display panel. The display device of the invention can improve the stability of the positioning of the display panel, and can have a corresponding adjustment space with high elasticity when the display panel is deformed, and can reduce or avoid the invasion of dusts or impurities.

### BRIEF DESCRIPTION OF THE DRAWINGS

FIG. 1A is a schematic plan view of an embodiment of the display device of the invention.

FIG. 1B is a partially cross-sectional view of the display device of FIG. 1A along a cutting line A-A′.

FIG. 2A and FIG. 2B are schematic views of an embodiment of the invention showing the block abutting against the first convex structure.

FIG. 3A to FIG. 3C are schematic views of different embodiments of the arrangement of the first convex structure of the invention.

FIG. 4 is a schematic view of another embodiment of the invention showing the first convex structure arranged at a specific region of the frame.

FIG. 5A to FIG. 5D are schematic views of different embodiments of the shape of the cross section of the first convex structure of the invention.

FIG. 6 is a partially cross-sectional view of another embodiment of the display device of the invention.

FIG. 7 is a partially cross-sectional view of yet another embodiment of the display device of the invention.

FIG. 8 is a partially cross-sectional view of further another embodiment of the display device of the invention.

FIG. 9 is a partially cross-sectional view of another embodiment of the display device of the invention.

FIG. 10 is a partially cross-sectional view of yet another embodiment of the display device of the invention.

### DETAILED DESCRIPTION OF THE PREFERRED EMBODIMENT

Various embodiments will be described below, and those having ordinary skill in the art can easily understand the spirit and principles of the invention with reference to the description and accompanying drawings. However, although some specific embodiments will be specifically described, these embodiments are merely illustrative, and are not considered to be restrictive or exhaustive in every respect. Therefore, for those having ordinary skill in the art, various changes and modifications to the invention should be obvious and easily achievable without departing from the spirit and principles of the invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” or “connected to” another element, it can be directly on or connected to the other element or intervening elements may also be present. In contrast, when an element is referred to as being “directly on” or “directly connected to” another element, there are no intervening elements present. As used herein, “connection” can be referred to physical or electrical connection. Moreover, “electrically connecting” or “coupling” can have other elements between two elements.

It should be understood that, even though the terms such as “first”, “second”, “third” may be used to describe an element, a part, a region, a layer and/or a portion in the present specification, but these elements, parts, regions, layers and/or portions are not limited by such terms. Such terms are merely used to differentiate an element, a part, a region, a layer and/or a portion from another element, part, region, layer and/or portion. Therefore, in the following discussions, a first element, portion, region, layer or portion may be called a second element, portion, region, layer or portion, and do not depart from the teaching of the present disclosure.

The terminology used herein is only for the purpose of describing particular embodiments and is not restrictive. As used herein, unless the content clearly indicates, the singular forms “a”, “an”, and “the” are intended to include the plural forms, including “at least one.” “Or” means “and/or”. As used herein, the term “and/or” includes any and all combinations of one or more of the associated listed items. It should also be understood that when used in this specification, the terms “comprising” and/or “including” specify the presence or addition of the described features, regions, wholes, steps, operations, elements and/or components, but do not exclude one or the presence or addition of multiple other features, regions, wholes, steps, operations, elements, components, and/or combinations thereof.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

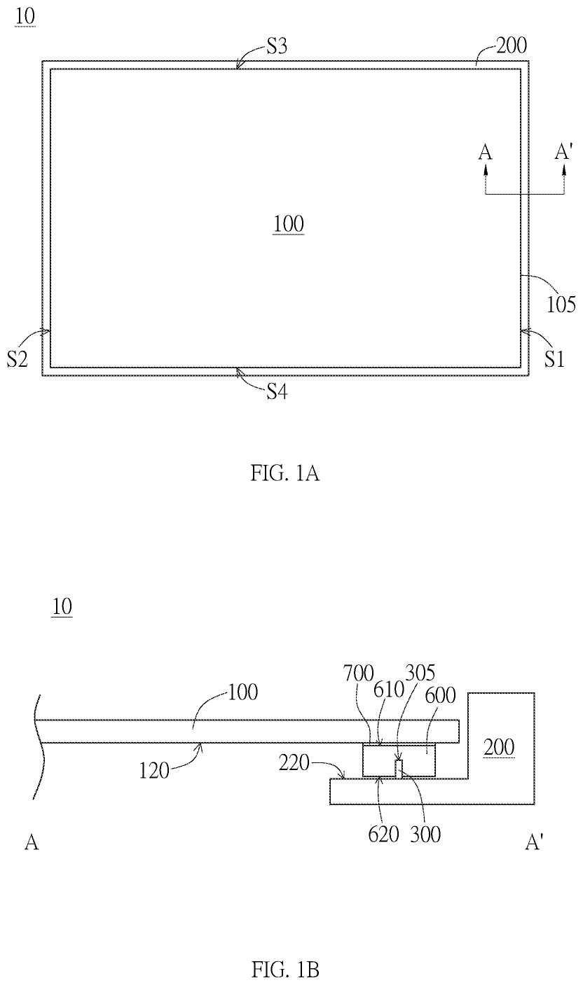

Referring to the schematic plan view of the display device 10 shown in FIG. 1A, the configuration and structure according to various embodiments of the invention can be applied to at least a portion of the periphery of the display device 10 to achieve the positioning of the display panel 100 and the frame 200. Specifically, without conflicting with other structures, the configuration and structure according to various embodiments of the invention may be implemented on at least a portion of the periphery 105 of the display panel 100, such as the first side S1, the second side S2, the third side S3, and/or the fourth side S4, and the invention is not limited to the configuration of the embodiments specifically mentioned herein.

Referring to FIG. 1A as well as the partially cross-sectional view of the display device 10 along the cutting line A-A′ shown in FIG. 1B, in an embodiment, the display device 10 includes a display panel 100, a frame 200 disposed along the periphery 105 of the display panel 100, a first convex structure 300 protruding from the frame 200 toward the display panel 100, and a block 600 connected to the display panel 100.

Specifically, the display panel 100 has a bottom surface 120, and the frame 200 has a support surface 220, which is opposite to the bottom surface 120. The first convex structure 300 protrudes from the support surface 220 and is located between the support surface 220 and the bottom surface 120. The block 600 has a first surface 610 and a second surface 620. The first surface 610 of the block 600 is connected to the bottom surface 120 of the display panel 100 by any suitable connection means. For example, an adhesive component 700 can be disposed on the first surface 610, and the block 600 is connected to the bottom surface 120 by the adhesive component 700. The second surface 620 of the block 600 is opposite to the first surface 610 and corresponds to the first convex structure 300. The second surface 620 of the block 600 at least partially abuts against a top portion 305 of the first convex structure 300. The adhesive component 700 can be a double-sided tape or a layer of glue coating, but not limited thereto.

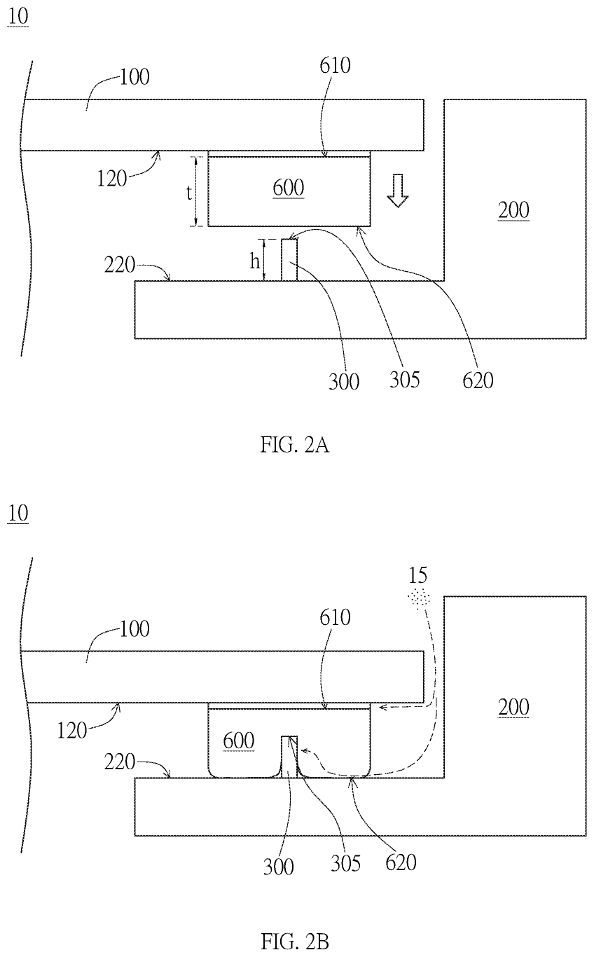

In an embodiment, the block 600 has a flexibility larger than that of the first convex structure 300. For example, the block 600 may have a Young's modulus smaller than that of the first convex structure 300; that is, the block 600 is more flexible and preferably have elasticity. For example, the block 600 can be made of soft materials, such as foams, and the first convex structure 300 can be made of materials relatively harder than foams, such as rubber or metals. As such, the flexibility of the block 600 can be larger than that of the first convex structure 300. Further referring to FIG. 2A and FIG. 2B, when the second surface 620 of the block 600 at least partially abuts against the top portion 305 of the first convex structure 300, the pressing force of the first convex structure 300 exerted on the block 600 will cause the block 600 to partially deform, and the shape of the portion of the block 600 abutting against the first convex structure 300 is changed conformally with the shape of the first convex structure 300. As such, the top portion 305 of the first convex structure 300 is partially enclosed by (or sunk in) the partially deformed block 600, and the display panel 100 is positioned on the frame 200 by the engagement or interference of the block 600 with the first convex structure 300. With such a configuration, the support surface 220 correspondingly supports the bottom surface 220, and the display panel 100 is indirectly supported by the frame 200 through the block 600 and the first convex structure 300.

In an embodiment, the block 600 can be made of materials with elasticity or memory, and the block 600 can at least partially return to its original shape when not in contact with the first convex structure 300 to improve the convenience and reliability of rework. The materials of the block 600 and the first convex structure 300 are exemplary, and the materials of the block 600 and the first convex structure 300 are not limited to the embodiments. Materials capable of enabling the block 600 to deform as in contact with the first convex structure 300 are applicable to the invention.

In an embodiment, the first convex structure 300 can be substantially integrally formed with the frame 200, and the first convex structure 300 and the frame 200 are formed of a same material. In another embodiment, the first convex structure 300 can be attached to the support surface 220 of the frame 200 by coating, hot melting, or adhering, but not limited thereto.

As shown in FIG. 2A, in order to prevent the first convex structure 300 from directly interfering with or abutting against the display panel 100 when the display panel is disposed on the frame 200, a height “h” of the first convex structure 300 protruding from the support surface 220 toward the bottom surface 120 is smaller than a thickness “t” of the block 600 extending from the bottom surface 120 toward the support surface 220. That is, in an embodiment, the thickness “t” is the distance between the first surface 610 and the second surface 620 of the block 600.

As shown in FIG. 2B, the block 600 abuts against the first convex structure 300 and then locally deforms to enclose a portion of the first convex structure 300 (e.g. the top portion 305), so as to stably position the display panel 100 on the frame 200. Moreover, the display device 10 can be completely sealed or substantially completely sealed at where the block 600 abuts against the first convex structure 300, so as to improve the sealing degree of assembly and reduce the occurrence of air gap. As such, contaminants 15 such as dusts, impurities can be prevented from entering the display panel 100 or the display device 10 through the gap between the bottom surface 120 and the support surface 220. With such a configuration that the display panel 100 is not directly adhered to the frame 200, when the display panel 100 undergoes expansion, contraction, warpage, or deformation of other forms or causes, the display panel 100 will not be pulled or restrained by the frame 200, thereby reducing or avoiding further deformation of the display panel 100 or damage to the internal configuration. Moreover, when deformation of the display panel 100 occurs, the block 600 connected to the display panel 100 deforms correspondingly to maintain close interference with the first convex structure 300. As such, the display panel 100 can be stably positioned without being pulled by the frame 200, and the tightness between the display panel 100 and the frame 200 can be maintained.

In an embodiment, in the case that the block 600 abuts against the first convex structure 300 and locally deforms, the block 600 can partially contact the support surface 220 or even not contact the support surface 220. In other words, the second surface 620 of the block 600 may partially contact or may not contact the support surface 220. The block 600 deforms corresponding to the deformation of the display panel 100 and the interference with the first convex structure 300, so the position and the portion of the block 600 in contact with the support surface 220 will be accordingly modified. That is, the deformation configuration of the block 600 and the position and the portion of the block 600 in contact with the support surface 220 are not absolutely fixed.

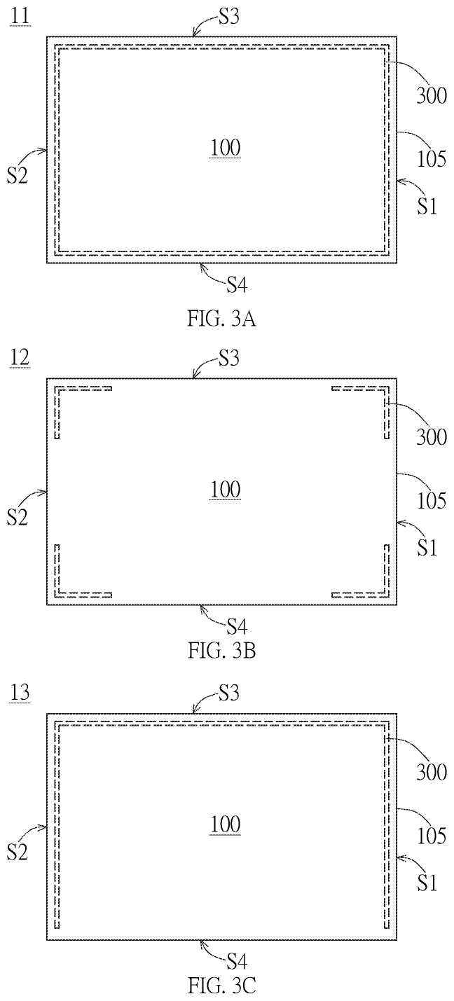

Referring to the plan views of different embodiments of the display devices 11, 12, and 13 shown in FIG. 3A to FIG. 3C, the location of the first convex structure 300 relative to the display panel 100 is illustrated to explain to the arrangement of the first convex structure 300. According to the embodiments, the first convex structure 300 can be distributed along at least a portion of the periphery 105 of the display panel 100. For example, as shown in FIG. 3A, in an embodiment, the first convex structure 300 can completely surround the periphery 105 of the display panel 100 to be continuously disposed on the support surface 220 (not shown) along the first side S1, the second side S2, the third side S3, and the fourth side S4 of the bottom surface 120 of the display panel 100. As shown in FIG. 3B, in another embodiment, the first convex structures 300 are disposed on the support surface 220 (not shown) corresponding to corners of the periphery 105 of the display panel 100 and spaced apart from each other along the first side S1, the second side S2, the third side S3, and the fourth side S4. As shown in FIG. 3C, in the case that the first side S4 is disposed with structures, which are configured to electrically connect other components, the first convex structure 300 can be disposed on the support surface 220 (not shown) to surround the periphery 105 of the display panel 100 along the first side S1, the second side S2, and the third side S3 similar to the embodiment of FIG. 3A, except the fourth side S4.

In order to ensure the reliability of assembly and the stability of positioning, in an embodiment, the first convex structure 300 can be continuously disposed on the support surface 220 along at least one side (e.g. the first side S1) of the bottom surface 120 of the display panel 100. In other words, the first convex structure 300 is preferably disposed as completely as possible to surround the periphery 105 of the display panel 100, but not limited thereto. In other embodiments, the first convex structure 300 can be locally distributed according to practical requirements.

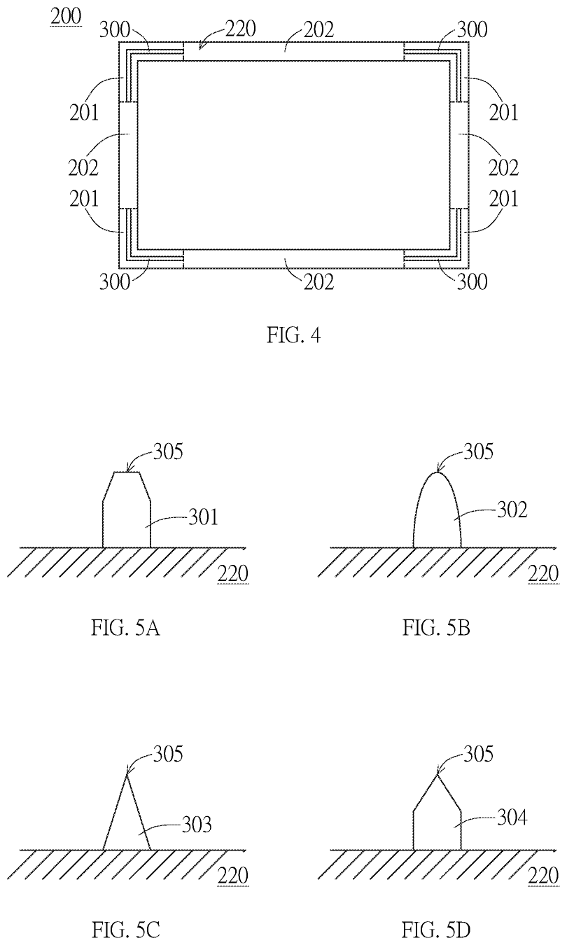

For example, in an embodiment, the first convex structure 300 can be arranged at a position where a gap between the support surface 220 and the bottom surface 120 is likely generated or a position where movement is likely occurred. FIG. 4 shows the first convex structure 300 arranged on the support surface 220 of the frame 200. For explanations, structures or elements other than the support surface 220 of the frame 200 and the first convex structure 300 are omitted in FIG. 4. The support surface 220 includes a first region 201 and a second region 202, and the first convex structure 300 is disposed at the first region 201 according to the arrangement of FIG. 3B. In this embodiment, the distance between the support surface 220 at the first region 201 and the bottom surface 120 can be larger than the distance between the support surface 220 at the second region 201 and the bottom surface 120. That is, the first convex structure 300 can be partially disposed on an area, which is expected to easily expand the distance between the support surface 220 and the bottom surface 120 or where movements are expected when the display panel 100 undergoes expansion, contraction, warpage, or deformation of other forms or causes. As such, less materials can be used to achieve the effects of increasing the positioning stability, reducing restraining and pulling of the display panel 100, and preventing dusts, impurities from entering the display panel 100 or the display device 10.

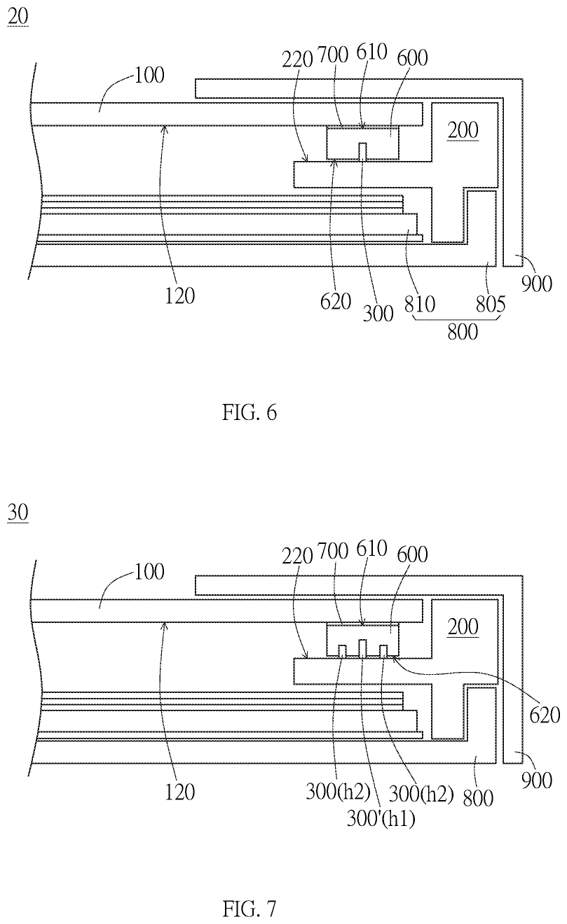

Referring to FIG. 5A to FIG. 5D, various embodiments of the first convex structure are illustrated. In the above embodiments, such as shown in FIG. 1B, the width of the cross section of the first convex structure 300 in a direction perpendicular to an extending direction of the support surface 220 and the frame 200 is substantially constant. For example, the first convex structure 300 can be a rectangular column extending along the extending direction of the frame 200. In another embodiment, the width of the cross section of the first convex structure 300 in the direction perpendicular to the extending direction of the support surface 220 and the frame 200 is gradually decreased toward the bottom surface 120. For example, as shown in FIG. 5A, the cross section of the first convex structure 301 can be narrowed at the top portion 305, and the top portion 305 can have a trapezoid-like shape. As shown in FIG. 5B, the cross section of the first convex structure 302 can have a bullet shape. As shown in FIG. 5C, the cross section of the first convex structure 303 can have a triangular shape. As shown in FIG. 5D, the cross section of the first convex structure 304 can have a pentagonal shape. The first convex structures 301 to 304 shown in FIG. 5A to FIG. 5D all have a gradually decreased width, and the narrowest width is at the top portion 305. Such first convex structures with narrower top portions can better concentrate the force on the top portion 305, so that the block 600 abutting thereon can be more easily deformed to achieve the effects described above.

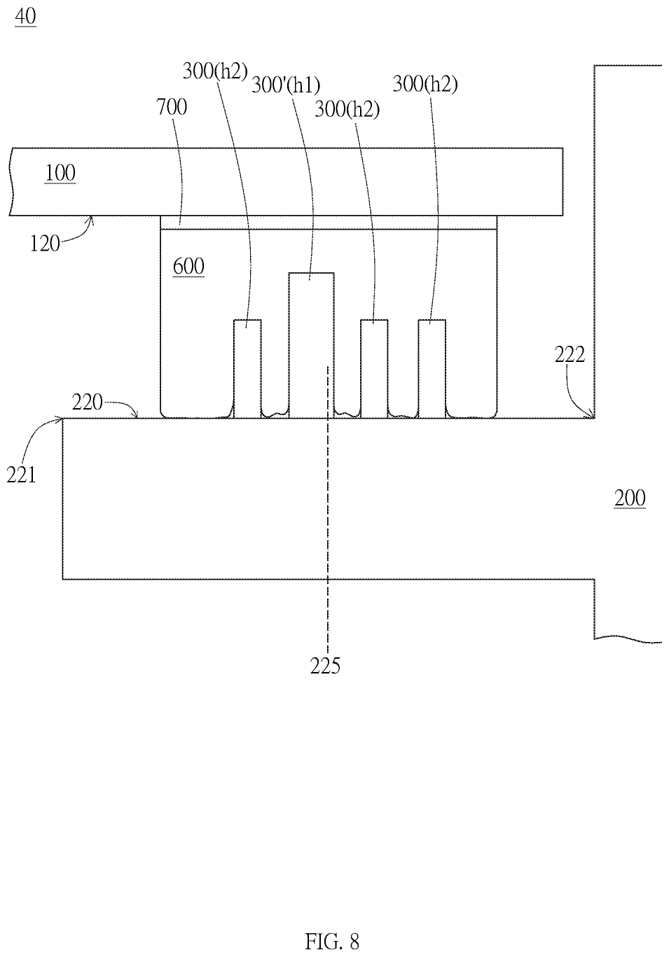

The frame 200 having the first convex structure 300 disposed on the support surface 220 can be applied to various types of display devices and not limited to the display device 10 of FIG. 1B. Referring to FIG. 6, in another embodiment, the display device 20 further includes a backlight module 800 and a cover 900, and the block 600 connected to the bottom surface 120 of the display panel 100 at least partially abuts against the first convex structure 300 on the support surface 220 of the frame 200.

In this embodiment, in addition to the employment of the cover 900 and the backlight module 800, which includes a light guide component 810 and a bezel 805, the configuration of the display device 20 of FIG. 6 is similar to that of the embodiments of FIG. 1A to FIG. 5D and will not be elaborated again. Moreover, the configuration according to the embodiments of the invention can be used in substantially any display device having the display panel 100 disposed on the frame 200. The embodiments of the display device described herein are only examples, and the invention is not limited to the embodiments.

Referring to FIG. 7, the display device 30 of another embodiment is illustrated. The structures of FIG. 7 that are similar to or same as those of FIG. 6 will not be elaborated again.

In the embodiment of FIG. 7, the display device 30 has a plurality of first convex structures, such as 300, 300′, on the support surface 220 of the frame 200. For example, three first convex structures 300, 300′ are illustrated. Similar to the first convex structure 300 described above, the first convex structures 300, 300′ respectively extend along the frame 200 and are arranged side by side in the direction perpendicular to the extending direction of the frame 200. As such, the number of the first convex structures 300, 300′ that the block 600 can abut is increased, so as to more stably position the display panel 100, improve the sealing degree between the bottom surface 120 of the display panel 100 and the support surface 220 of the frame 200, and reduce the pulling effect exerted on the display panel 100 by the frame 200.

In this embodiment, the heights of the first convex structures 300, 300′ protruding from the support surface 220 can be the same or different. For example, the height “h1” of a main first convex structure 300′, which is arranged at center in the order of the plurality of first convex structures 300, 300′, protruding from the support surface 220 is larger than the height “h2” of the other first convex structures 300 protruding from the support surface 220. As such, when the block 600 moves toward the support surface 220, the block 600 will firstly come into contact with the main first convex structure 300′ arranged at the center and deform, and the portions of the block 600 at two sides of the main first convex structure 300′ will then come into contact with the other first convex structures 300 and deform. Accordingly, the block 600 deforms to engage with the first convex structures 300, 300′ in a sealing state with force more evenly distributed, but not limited thereto.

Referring to the display device 40 of FIG. 8, the main first convex structure 300′ can be a convex structure arranged at any suitable position in the order other than at the center. For example, when the total number of the first convex structures 300, 300′ is an even number, the main first convex structure 300′ having a larger height can be arranged close to the center. Specifically, the support surface 220 has a central position 225 between the edge 221 closer to the inner side of the display panel 100 and the edge 222 farther away from the inner side of the display panel 100. The height “h1” of the main first convex surface 300′ of the plurality of first convex structures 300, 300′ closest to the central position 225 protruding from the support surface 220 is larger than the height “h2” of the others of the plurality of first convex structures (e.g. 300) protruding from the support surface 220. Accordingly, the block 600 deforms to engage with the first convex structures 300, 300′ in a sealing state with force more evenly distributed. In this embodiment, the central position 225 is determined with respect to the center of the support surface 220, but not limited thereto. In another embodiment, the central position 225 can be determined with respect to the center of the block 600 or with respect to the center of the vertical projection of the display device 100 on the support surface 220, but not limited thereto.

In addition to the first convex structure 300 and/or 300′, which causes a local deformation of the block 600 when abutting thereon, the display device of the invention may further include other convex structures. Specifically, as shown in FIG. 9, in an embodiment, the display device 50 can further include a second convex structure 420. The second convex structure 420 protrudes from the support surface 220 toward the bottom surface 120 and is located between the block 600 and the edge 221 of the support surface 100 that is closer to the inner side of the display panel 100.

Similar to the first convex structure 300, the second convex structure 420 can be integrally formed with the frame 200 or can be attached to the support surface 220 of the frame 200 by coating, hot melting, or adhering. The block 600 can be more accurately positioned by aligning with the second convex structure 420 to reduce the possibility that the block 600 unexpectedly moves toward the inner side of the display panel 100. That is, in an embodiment, the second convex structure 420 can function as a restriction component, but not limited thereto.

In an embodiment, similar to the first convex structure 300, the flexibility of the block 600 can be larger than that of the second convex structure 420. In other words, the second convex structure 420 may have a Young's modulus larger than that of the block 600.

In order to accurately position the display panel 100 and prevent the block 600 from moving, in an embodiment, the second convex structure 420 can substantially abut against a lateral surface 630 of the block 100, which faces the inner side of the display panel 100, but not limited thereto. In another embodiment, the second convex structure 420 can have a gap with the lateral surface 630 of the block 100 facing the inner side of the display panel 100. In yet another embodiment, the second convex structure 420 can not only abut against the lateral surface 630 of the block 100 facing the inner side of the display panel 100, but also slightly abut against the edge of the second surface 620 of the block 600. That is, the lateral surface 630 and the second surface 620 of the block 600 can deform to abut against the second convex structure 420 at the same time. In the case that the second convex structure 420 can achieve the alignment of the block 600 and/or reduce the misalignment of the block 600, the contact position of the second convex structure 420 and the deformable block 600 can be modified, and not limited to the embodiments.

In the embodiment of FIG. 9, except the second convex structure 420, the structures or connections of other elements are similar to those of FIG. 6, for example both including the backlight module 800 and the cover 900, and not elaborated again.

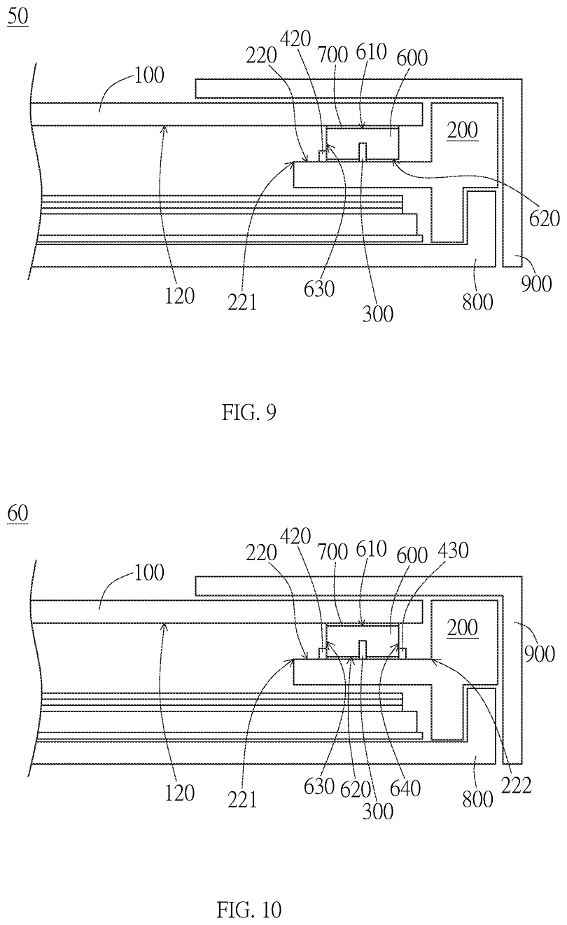

Referring to FIG. 10, in addition to the first convex structure 300 and/or 300′ and the second convex structure 420, in an embodiment, the display device 60 further includes a third convex structure 430. The third convex structure 430 protrudes from the support surface 220 toward the bottom surface 120 and is located between the block 600 and the edge 222 of the support surface 220, which is away from the inner side of the display panel 100.

Similar to the first convex structure 300, the third convex structure 430 can be integrally formed with the frame 200 or can be attached to the support surface 220 of the frame 200 by coating, hot melting, or adhering. In addition to the second convex structure 420, the block 600 can be more accurately positioned by aligning with the third convex structure 430 to reduce the possibility that the block 600 unexpectedly moves toward the outer side of the display panel 100. That is, in an embodiment, the third convex structure 430 can function as a restriction component, but not limited thereto.

In an embodiment, similar to the first convex structure 300, the flexibility of the block 600 can be larger than that of the third convex structure 430. In other words, the third convex structure 430 may have a Young's modulus larger than that of the block 600.

In order to accurately position the display panel 100 and prevent the block 600 from moving, in the embodiment shown in FIG. 10, the third convex structure 430 can substantially abut against a lateral surface 640 of the block 100, which is closer to the outer side of the display panel 100 or faces away from the inner side of the display panel 100, but not limited thereto. In another embodiment, the third convex structure 430 can have a gap with the lateral surface 640 of the block 100 facing the outer side of the display panel 100. In yet another embodiment, the third convex structure 430 can not only abut against the lateral surface 640 of the block 100 facing the outer side of the display panel 100, but also slightly abut against the edge of the second surface 620 of the block 600. That is, the lateral surface 640 and the second surface 620 of the block 600 can deform to abut against the third convex structure 430 at the same time. In the case that the third convex structure 430 can achieve the alignment of the block 600 and/or reduce the misalignment of the block 600, the contact position of the third convex structure 430 and the deformable block 600 can be modified, and not limited to the embodiments.

In the embodiment of FIG. 10, except the third convex structure 430, the structures or connections of other elements are similar to those of FIG. 9 and not elaborated again. Moreover, in another embodiment, the display device may have the third convex structure 430 without the second convex structure 420, and the embodiments of FIG. 9 and FIG. 10 are merely exemplary.

The display device in various embodiments can stably position the display panel on the frame by pressing the first convex structure into the deformable block. When the display panel undergoes expansion, contraction, warpage, or deformation of other forms or causes, due to the conformal deformation of the block, the display panel can maintain a stable connection with the frame without being pulled by the frame, thereby reducing the possibility of degrading or damaging the configuration or appearance of the display panel, and preventing contaminants (e.g. dusts, impurities) from entering the display device through the gap between the display panel and the frame.

Although the preferred embodiments of the invention have been described herein, the above description is merely illustrative. The preferred embodiments disclosed will not limit the scope of the invention. Further modification of the invention herein disclosed will occur to those skilled in the respective arts and all such modifications are deemed to be within the scope of the invention as defined by the appended claims.

What is claimed is:

1. A display device, comprising:
a display panel having a bottom surface;
a frame disposed along a periphery of the display panel, the frame having a support surface configured to support the bottom surface;
a first convex structure protruding from the support surface and located between the support surface and the bottom surface, the first convex structure distributed along at least a portion of the periphery of the display panel; and
a block having a first surface and a second surface, the first surface connected to the bottom surface, the second surface at least partially abutting against a top portion of the first convex structure to cause a local deformation of the block, wherein the block has a flexibility larger than that of the first convex structure.

2. The display device of claim 1, wherein an adhesive component is disposed on the first surface, and the block is connected to the bottom surface by the adhesive component.

3. The display device of claim 1, wherein the display device comprises a plurality of the first convex structures; the plurality of first convex structures extend along the frame and are arranged side by side in a direction perpendicular to an extending direction of the frame.

4. The display device of claim 3, wherein a height of a main first convex structure arranged at center in the order of the plurality of first convex structures is larger than a height of the others of the plurality of first convex structures protruding from the support surface.

5. The display device of claim 3, wherein the support surface has a central position between an edge closer to an inner side of the display panel and an edge farther away from the inner side of the display panel, and a height of a main first convex surface of the plurality of first convex structures closest to the central position protruding from the support surface is larger than a height of the others of the plurality of first convex structures protruding from the support surface.

6. The display device of claim 1, wherein the first convex structure is continuously disposed on the support surface along a first side of the bottom surface.

7. The display device of claim 1, wherein the support surface has a first region and a second region, the first convex structure is disposed at the first region, and a distance between the support surface at the first region and the bottom surface is larger than a distance between the support surface at the second region and the bottom surface.

8. The display device of claim 1, wherein a width of a cross section of the first convex structure in a direction perpendicular to an extending direction of the support surface and the frame is gradually decreased toward the bottom surface.

9. The display device of claim 8, wherein the cross section of the first convex structure in the direction perpendicular to the extending direction of the support surface and the frame has a triangular shape, a bullet shape, or a pentagonal shape.

10. The display device of claim 1, wherein the first convex structure is integrally formed with the frame, and the first convex structure and the frame are formed of a same material.

11. The display device of claim 1, wherein a height of the first convex structure protruding from the support surface toward the bottom surface is smaller than a thickness of the block extending from the bottom surface toward the support surface.

12. The display device of claim 1, further comprising a second convex structure, wherein the second convex structure protrudes from the support surface toward the bottom surface and is located between the block and an edge of the support surface closer to an inner side of the display panel.

13. The display device of claim 12, wherein the second convex structure abuts against a lateral surface of the block facing the inner side of the display panel.

14. The display device of claim 12, further comprising a third convex structure, wherein the third convex structure protrudes from the support surface toward the bottom surface and is located between the block and an edge of the support surface farther away from the inner side of the display panel.

15. The display device of claim 14, wherein the third convex structure abuts against a lateral surface of the block facing away from the inner side of the display panel.
